(19) United States
(12) Patent Application Publication
(10) Pub. No.: US 2013/0182649 A1
(43) Pub. Date: Jul. 18, 2013

(54) APPARATUS AND METHOD FOR ACTIVATING A COMPONENT CARRIER IN A MULTIPLE COMPONENT CARRIER SYSTEM

(71) Applicants: Ki Bum Kwon, Seoul (KR); Myung Cheul Jung, Seoul (KR)

(72) Inventors: Ki Bum Kwon, Seoul (KR); Myung Cheul Jung, Seoul (KR)

(73) Assignee: Pantech Co., Ltd., Seoul (KR)

(21) Appl. No.: 13/824,524

(22) PCT Filed: Sep. 7, 2011
(86) PCT No.: PCT/KR2011/006598

§ 371 Date: Mar. 18, 2013

(30) Foreign Application Priority Data
Sep. 17, 2010 (KR) 10-2010-0092112

(51) Int. Cl. H04W 76/02

(52) U.S. Cl. CPC H04W 76/025
USPC 370/328

(57) ABSTRACT

An apparatus and method for activating a component carrier in a multiple component carrier system including the steps of: receiving component carrier setting information about a first uplink component carrier, which is connected with a first downlink component carrier corresponding to a secondary serving cell of a UE, from a base station; setting the first uplink component carrier on the basis of the component carrier setting information; and activating the initial state of the set first uplink component carrier according to the activation state of the first downlink component carrier. Accordingly, the ambiguity of the initial state of an uplink component carrier additionally set between the UE and the base station can be removed.

### CROSS-REFERENCE TO RELATED APPLICATIONS

This Application is the National Stage Entry of International Application No. PCT/KR2011/006598, filed on Sep. 7, 2011, and claims priority to and the benefit of Korean Patent Application No. 10-2010-0092112, filed on Sep. 17, 2010, all of which are incorporated herein by reference as if fully set forth herein.

### BACKGROUND

1. Field

The present invention relates to wireless communication and, more particularly, to an apparatus and method for activating a component carrier in a multiple component carrier system.

2. Discussion of the Background

Cellular is a concept proposed to overcome a restriction to a service area and the limits of the frequency and subscriber capacity. Cellular is a method of providing coverage by changing a single high-output base station into a plurality of low-output base stations. That is, a mobile communication service area is divided into several small cells, different frequencies are allocated to neighbour cells, and the same frequency band is used in two cells sufficiently spaced apart from each other without interference therebetween so that the frequency can be spatially reused.

A handover or handoff refers to a function in which, when a UE moves, gets out of a current communication service area (hereinafter referred to as a serving cell), and then moves to a neighbour communication service area (hereinafter referred to as a neighbour cell), the UE is automatically tuned with the new traffic channel of the neighbour cell so that the UE continues to maintain a traffic state. A UE communicating with a specific base station (hereinafter referred to as a source base station) is linked to another neighbour base station (hereinafter referred to as a target base station) when the intensity of a signal from the source base station becomes weak. When a handover is performed, a problem, such as call disconnection occurring when a UE moves to a neighbour cell, can be solved.

Meanwhile, a wireless communication system commonly uses one bandwidth for data transmission. For example, the 2^{nd} generation wireless communication system uses a bandwidth of 200 KHz to 1.25 MHz, and the 3^{rd} generation wireless communication system uses a bandwidth of 5 MHz to 10 MHz. In order to support an increasing transfer capacity, the bandwidth of the recent 3GPP LTE or 802.16m continues to extend up to 20 MHz or higher. To increase the bandwidth can be considered to be indispensable so as to increase the transfer capacity, but to support a great bandwidth even when quality of service required is low can generate great power consumption.

There is emerging a multiple component carrier system in which a carrier having one bandwidth and the center frequency is defined and data can be transmitted and/or received through a plurality of the carriers using a wide band. The multiple component carrier system supports a narrow band and a wide band at the same time by using one or more carriers. For example, if one carrier corresponds to a bandwidth of 5 MHz, a maximum of a 20 MHz bandwidth is supported by using four carriers.

If a new component carrier is sought to be additionally configured in a UE in a wireless communication system in which a plurality of component carriers operates, the activation and deactivation of the additionally configured component carrier have not yet been defined.

### SUMMARY

An object of the present invention is to provide an apparatus and method for activating a component carrier.

Another object of the present invention is to provide an apparatus and method for deactivating a component carrier.

Yet another object of the present invention is to provide an apparatus and method for initializing the activation of an uplink component carrier connected to a downlink component carrier.

Yet another object of the present invention is to provide an apparatus and method for initializing the deactivation of an uplink component carrier connected to a downlink component carrier.

Yet another object of the present invention is to provide an apparatus and method for transmitting information indicative of the activation of an uplink component carrier.

Yet another object of the present invention is to provide an apparatus and method for selecting an uplink component carrier to be configured additionally.

In accordance with an aspect of the present invention, a method of a UE activating a component carrier in a multiple component carrier system includes the steps of receiving, from a base station, component carrier configuration information on a first uplink component carrier linked to a first downlink component carrier corresponding to the secondary serving cell of the UE, configuring the first uplink component carrier based on the component carrier configuration information, and activating the initial state of the configured first uplink component carrier according to the activation state of the first downlink component carrier.

In accordance with another aspect of the present invention, a method of a UE configuring a component carrier in a multiple component carrier system includes the steps of receiving component carrier configuration information for configuring a secondary component carrier from a base station, configuring a secondary component carrier, indicated by the component carrier configuration information, in the UE, and setting an initial state of the secondary component carrier as activation or deactivation.

In accordance with yet another aspect of the present invention, a UE for configuring a component carrier in a multiple component carrier system includes a message reception unit for receiving component carrier configuration information for configuring a secondary component carrier from a base station and an uplink component carrier configuration unit for configuring a secondary component carrier, indicated by the component carrier configuration information, in the UE and setting the initial state of the secondary component carrier as activation or deactivation.

In accordance with further yet another aspect of the present invention, a method of a base station configuring a component carrier in a multiple component carrier system includes the steps of transmitting component carrier configuration information for configuring a secondary component carrier to a UE, receiving a component carrier configuration completion message, indicating that the configuration of the secondary component carrier has been completed based on the component carrier configuration information, from the UE, transmitting an activation indicator indicative of the activation of the secondary component carrier to the UE if the initial state of the secondary component carrier is set as deactivation, and receiving an activation completion message, indicating that the activation of the secondary component carrier has been completed, from the UE.

In accordance with still yet another aspect of the present invention, a base station for configuring a component carrier in a multiple component carrier system includes a message transmission unit for transmitting component carrier configuration information for configuring a secondary component carrier to a UE and transmitting an activation indicator indicative of the activation of the secondary component carrier to the UE when the initial state of the secondary component carrier is set as deactivation and a message reception unit for receiving a component carrier configuration completion message, indicating that the configuration of the secondary component carrier has been completed based on the component carrier configuration information, from the UE and receiving an activation completion message, indicating that the activation of the secondary component carrier has been completed, from the UE.

In accordance with a method in which the initial state of an additionally configured uplink component carrier is basically deactivated and the uplink component carrier is activated when a base station transmits an additional activation indicator to a UE, if necessary, and a method of initializing the initial state of an additionally configured uplink component carrier in the same state as a downlink component carrier, the ambiguities of the initial state of the uplink component carrier additionally configured between the UE and the base station can be eliminated.

### BRIEF DESCRIPTION OF THE DRAWINGS

FIG. 1 is a block diagram showing a wireless communication system.

FIG. 2 is an explanatory diagram illustrating an intra-band contiguous carrier aggregation.

FIG. 3 is an explanatory diagram illustrating an intra-band non-contiguous carrier aggregation.

FIG. 4 is an explanatory diagram illustrating an inter-band carrier aggregation.

FIG. 5 shows an example of a protocol structure for supporting multiple carriers.

FIG. 6 shows an example of a frame structure for a multiple carrier operation.

FIG. 7 is a diagram showing linkage between a downlink component carrier and an uplink component carrier in a multiple carrier system.

FIG. 8 is an explanatory diagram illustrating the concept of a serving cell and a neighbour cell.

FIG. 9 is an explanatory diagram illustrating the concept of a primary serving cell and a secondary serving cell.

FIG. 10 is a flowchart illustrating a method of initializing a CC in a multiple component carrier system in accordance with an example of the present invention.

FIG. 11 is a flowchart illustrating a method of a UE initializing a CC in a multiple component carrier system in accordance with an example of the present invention.

FIG. 12 is a signal flow between a UE and a base station according to the initializing method of FIG. 11.

FIG. 13 is a flowchart illustrating a method of a base station initializing a CC in a multiple component carrier system in accordance with an example of the present invention.

FIG. 14 is a flowchart illustrating a method of a UE initializing a CC in a multiple component carrier system in accordance with another example of the present invention.

FIG. 15 is a flowchart illustrating a method of a base station initializing a CC in a multiple component carrier system in accordance with another example of the present invention.

FIG. 16 is a flowchart illustrating a method of selecting an UL CC to be additionally configured in accordance with an example of the present invention.

FIG. 17 is a conceptual diagram illustrating the method of selecting an UL CC according to FIG. 16.

FIG. 18 is a block diagram showing a UE and a base station in accordance with an example of the present invention.

FIG. 19 is a signal flow between a UE and a base station according to the methods of initializing an UL CC in FIGS. 14 and 20.

FIG. 20 is a flowchart illustrating a method of a UE initializing a CC in a multiple component carrier system in accordance with another example of the present invention.

### DETAILED DESCRIPTION OF THE ILLUSTRATED EMBODIMENTS

Hereinafter, in this specification, some embodiments of the present invention are described in detail with reference to exemplary drawings. It is to be noted that in assigning reference numerals to elements in each of the drawings, the same reference numerals designate the same elements throughout the drawings although the elements are shown in different drawings. Furthermore, in describing the embodiments of the present invention, a detailed description of the known functions and constructions will be omitted if it is deemed to make the gist of the present invention unnecessarily vague.

Furthermore, in describing the elements of this specification, terms, such as the first, the second, A, B, (a), and (b), may be used. However, the terms are used to only distinguish one element from the other element, but the essence, order, or sequence of the elements is not limited by the terms. When it is said that one element is “connected”, “combined”, or “coupled” with the other element, the one element may be directly connected or coupled with the other element, but it should be understood that a third element may be “connected”, “combined”, or “coupled” between the two elements.

Furthermore, in this specification, a wireless communication network is described as a target, and tasks performed in the wireless communication network can be performed in a process in which a system (e.g., a base station) managing the wireless communication network controls the wireless communication network and transmits data or can be performed by a UE that accesses the wireless communication network.

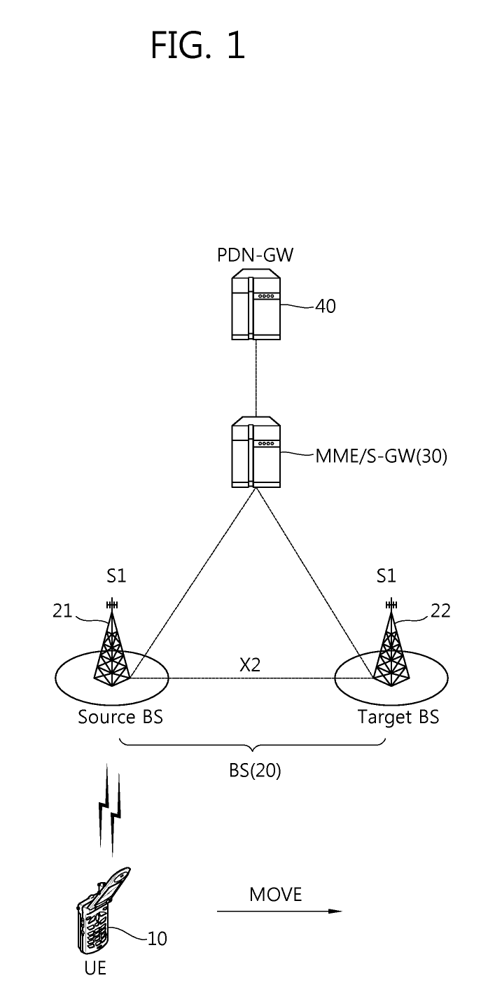

FIG. 1 is a block diagram showing a wireless communication system. The wireless communication system can be the network structure of an Evolved-Universal Mobile Telecommunications System (E-UMTS). The E-UMTS system may also be called a Long Term Evolution (LTE) system. The wireless communication systems are widely deployed in order to provide various types of communication services, such as voice and packet data.

Multiple access schemes applied to the wireless communication system are not limited. A variety of multiple access schemes, such as Code Division Multiple Access (CDMA), Time Division Multiple Access (TDMA), Frequency Division Multiple Access (FDMA), Orthogonal Frequency Division Multiple Access (OFDMA), Single Carrier Frequency Division Multiple Access (SC-FDMA), OFDM-FDMA, OFDM-TDMA, and OFDM-CDMA, can be used.

Here, uplink transmission and downlink transmission can be performed in accordance with a Time Division Duplex (TDD) scheme using different times or a Frequency Division Duplex (FDD) scheme using different frequencies.

Referring to FIG. 1, an E-UTRAN includes at least one Base Station (BS) 20 which provides a control plane and a user plane. User Equipment (UE) 10 can be fixed or mobile and can also be called another terminology, such as a Mobile Station (MS), an Advanced MS (AMS), a User Terminal (UT), a Subscriber Station (SS), or a wireless device.

The BS 20 commonly refers to a fixed station that communicates with the UE 10, and the BS 20 can also be called another terminology, such as an evolved-NodeB (eNodeB), a Base Transceiver System (BTS), an access point, a femto BS, a relay, or a transmission point. The BS 20 can provide service to at least one cell. The cell is a geographical area where communication service is provided or a specific frequency region. An interface for transmitting user traffic or control traffic may be used between the BSs 20. A source BS 21 refers to a BS that has set up a radio bearer with the UE 10, and a target BS 22 refers to a BS to which the UE 10 attempts a handover in order to set up a new radio bearer with the target BS 22 after breaking the existing radio bearer with the source BS 21.

Hereinafter, downlink refers to communication from the BS 20 to the UE 10, and uplink refers to communication from the UE 10 to the BS 20. Downlink is also called a forward link, and uplink is also called a reverse link. In downlink, a transmitter can be part of the BS 20 and a receiver can be part of the UE 10. In uplink, a transmitter can be part of the UE 10 and a receiver can be part of the BS 20.

The BSs 20 can be interconnected through an X2 interface. The X2 interface is used to exchange messages between the BSs 20. The BS 20 is connected to an Evolved Packet System (EPS), more particularly, a Mobility Management Entity (MME)/Serving Gateway (S-GW) 30 through an S1 interface. The S1 interface supports a many-to-many-relation between the BSs 20 and the MME/S-GW 30. In order to provide packet data service to the MME/S-GW 30, a PDN-GW 40 is used. The PDN-GW 40 is varied depending on a traffic purpose or service. The PDN-GW 40 supporting specific service can be searched for based on Access Point Name (APN) information.

An intra E-UTRAN handover is a basic handover mechanism that is used when a handover is performed between E-UTRAN access networks. The intra E-UTRAN handover includes an X2-based handover and an S1-based handover. The X2-based handover is used when the UE performs a handover from the source BS 21 to the target BS 22 using the X2 interface. Here, the MME/S-GW 30 is not changed.

Through the S1-based handover, a first bearer set up among the P-GW 40, the MME/S-GW 30, the source BS 21, and the UE 10 is released, and a second new bearer is set up among the P-GW 40, the MME/S-GW 30, the target BS 22, and the UE 10.

A Carrier Aggregation (CA) supports a plurality of component carriers, and the CA is also called a spectrum aggregation or a bandwidth aggregation. An individual unit carrier aggregated by the CA is also called a Component Carrier (hereinafter referred to as a CC). Each CC is defined by a bandwidth and the center frequency. The carrier aggregation is introduced in order to support an increasing throughput, prevent an increase of costs due to the introduction of broadband Radio Frequency (RF) devices, and guarantee compatibility with the existing system.

For example, assuming that 5 CCs each having a bandwidth of 5 MHz are allocated, a maximum of a 25 MHz bandwidth can be supported.

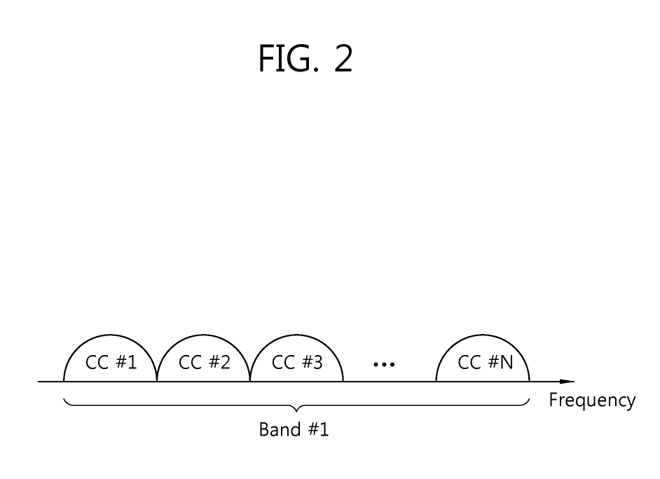

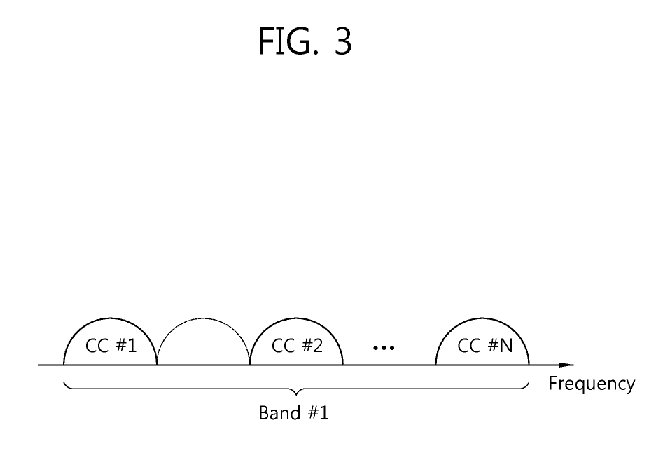

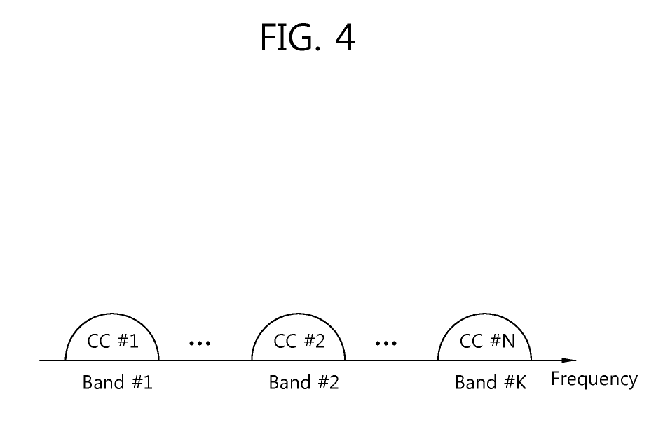

A carrier aggregation can be classified into an intra-band contiguous carrier aggregation, such as that shown in FIG. 2, an intra-band non-contiguous carrier aggregation, such as that shown in FIG. 3, and an inter-band carrier aggregation, such as that shown in FIG. 4.

First, referring to FIG. 2, the intra-band contiguous carrier aggregation is performed between CCs that are contiguous to each other within the same operating band. For example, all of a CC#1, a CC#2, a CC#3, . . . , a CC#N, that is, aggregated CCs, are contiguous to each other.

Referring to FIG. 3, the intra-band non-contiguous carrier aggregation is performed between non-contiguous CCs. For example, a CC#1 and a CC#2, that is, aggregated CCs, are spaced apart from each other at a specific frequency.

Referring to FIG. 4, in the inter-band carrier aggregation, when a plurality of CCs is present, one or more of the plurality of CCs are aggregated on different frequency bands. For example, a CC #1, that is, an aggregated CC, is present in an operating band #1 and a CC #2, that is, an aggregated CC, is present in an operating band #2.

The number of aggregated downlink CCs and the number of aggregated uplink CCs can be differently set. A case where the number of downlink CCs is identical with the number of uplink CCs is called a symmetric aggregation, and a case where the number of downlink CCs is different from the number of uplink CCs is called an asymmetrical aggregation.

Furthermore, CCs can have different sizes (i.e., bandwidths). For example, assuming that 5 CCs are used to form a 70 MHz band, a resulting configuration can be, for example, 5 MHz CC (a carrier #0)+20 MHz CC (a carrier #1)+20 MHz CC (a carrier #2)+20 MHz CC (a carrier #3)+5 MHz CC (a carrier #4).

Hereinafter, the term ‘multiple carrier system’ refers to a system which supports a carrier aggregation. In a multiple carrier system, a contiguous carrier aggregation and/or a non-contiguous carrier aggregation can be used. Furthermore, either a symmetrical aggregation or an asymmetrical aggregation can be used.

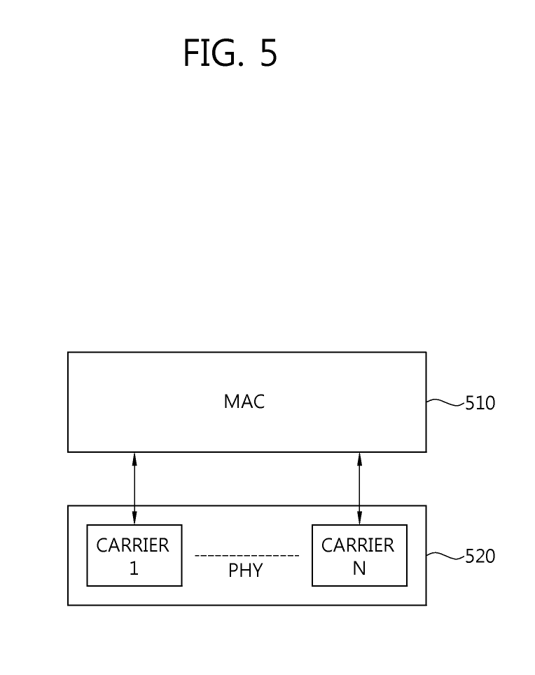

FIG. 5 shows an example of a protocol structure for supporting multiple carriers.

Referring to FIG. 5, a common Medium Access Control (MAC) entity 510 manages a physical layer 520 using a plurality of carriers. An MAC management message transmitted on a specific carrier can be applied to a different carrier. That is, the MAC management message is a message which can control other carriers including the specific carrier. The physical layer 520 can be operated in accordance with a TDD scheme and/or an FDD scheme.

Several physical control channels are present in the physical layer 520. A Physical Downlink Control CHannel (PDCCH) through which physical control information is transmitted informs UE of the resource allocation of a Paging CHannel (PCH) and a DownLink Shared CHannel (DL-SCH) and Hybrid Automatic Repeat Request (HARQ) information related to the DL-SCH. The PDCCH can carry an uplink grant that informs UE of the allocation of resources for uplink transmission.

A Physical Control Format Indicator CHannel (PCFICH) informs UE of the number of OFDM symbols used in PDCCHs, and the PCFICH is transmitted every frame. A Physical Hybrid ARQ Indicator CHannel (PHICH) carries an HARQ ACK/NAK signal in response to uplink transmission. A Physical Uplink Control CHannel (PUCCH) carries HARQ ACK/NAK for downlink transmission, a scheduling request, and uplink control information, such as a Channel Quality Indicator (CQI). A Physical Uplink Shared CHannel (PUSCH) carries an Uplink Shared CHannel (UL-SCH).

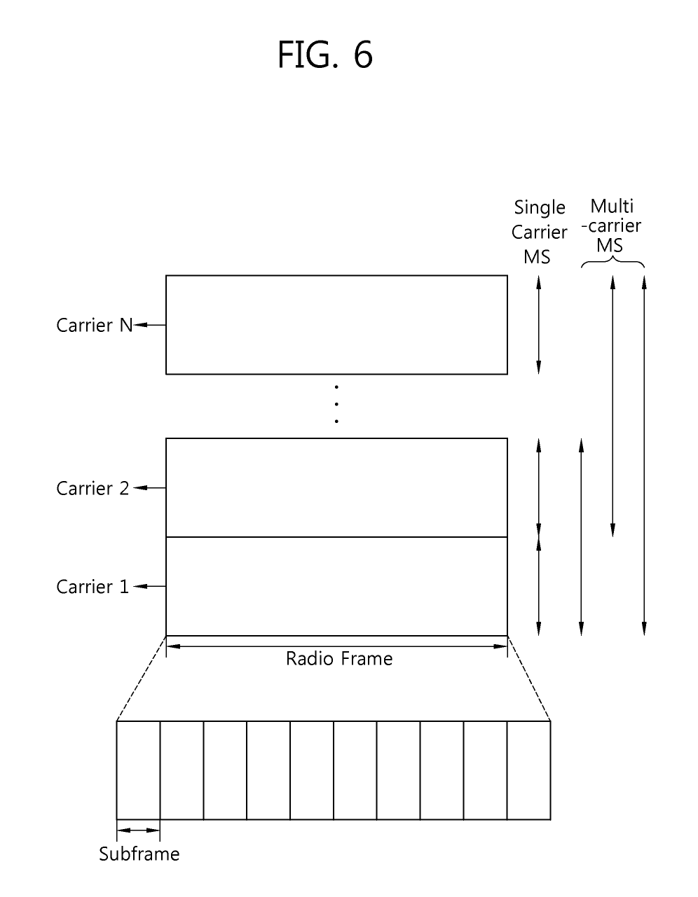

FIG. 6 shows an example of a frame structure for a multiple carrier operation.

Referring to FIG. 6, a radio frame consists of 10 subframes. Each of the subframes includes a plurality of OFDM symbols. Each CC can have its own control channel (e.g., a PDCCH). The CCs can be contiguous to each other or may not be contiguous to each other. UE can support one or more CCs depending on its capability.

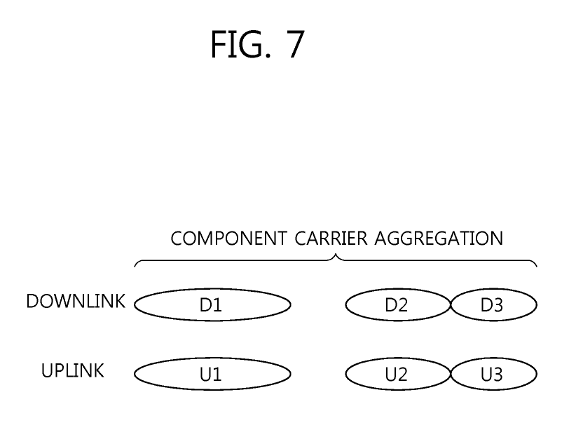

FIG. 7 is a diagram showing linkage between a downlink component carrier and an uplink component carrier in a multiple carrier system.

Referring to FIG. 7, in downlink, downlink CCs (hereinafter referred to as DL CCs) D1, D2, and D3 are aggregated. In uplink, uplink CCs (hereinafter referred to as UL CCs) U1, U2, and U3 are aggregated. Here, Di is the index of the DL CC, and Ui is the index of the UL CC (i=1, 2, 3).

In an FDD system, a DL CC and an UL CC are linked to each other in a one-to-one manner. Each of the D1 and the U1, the D2 and the U2, and the D3 and the U3 is linked to each other in a one-to-one manner. UE sets up linkage between the DL CCs and the UL CCs based on system information transmitted on a logical channel BCCH or a UE-dedicated RRC message transmitted on a DCCH. Each linkage can be set up in a cell-specific way or a UE-specific way.

Examples of an UL CC linked to a DL CC are as follows.

11) An UL CC on which UE will transmit ACK/NACK information in response to data transmitted by a BS through a DL CC,

2) A DL CC on which a BS will transmit ACK/NACK information in response to data transmitted by UE through an UL CC,

3) A DL CC on which a BS will transmit a response to a Random Access Preamble (RAP), transmitted by UE which starts a random access procedure through an UL CC, when the BS receives the RAP,

4) An UL CC to which uplink control information is applied when a BS transmits the uplink control information through a DL CC.

FIG. 7 illustrates only 1:1 linkage between a DL CC and an UL CC, but linkage, such as 1:n or n:1, can be set up. Furthermore, the index of a CC does not coincide with the order of the CC or the location of the frequency band of the CC.

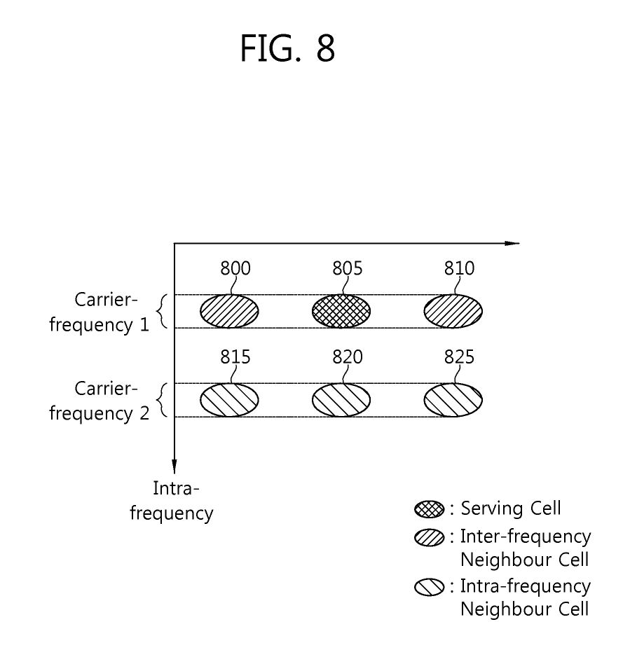

FIG. 8 is an explanatory diagram illustrating the concept of a serving cell and a neighbour cell.

Referring to FIG. 8, a system frequency band is classified into a plurality of carrier frequencies. Here, the carrier frequency refers to the center frequency of a cell. The cell can mean downlink frequency resources and uplink frequency resources. Or, the cell can mean a combination of downlink frequency resources and optional uplink frequency resources. In general, when a CA is not taken into consideration, one cell always includes a pair of uplink and downlink frequency resources.

Here, a serving cell 805 refers to a cell in which UE is now receiving service. A neighbour cell refers to a cell that neighbors the serving cell 805 geographically or on the frequency band. Neighbour cells using the same carrier frequency on the basis of the serving cell 805 are called intra-frequency neighbour cells 800 and 810. Furthermore, neighbour cells using different carrier frequencies on the basis of the serving cell 805 are called inter-frequency neighbour cells 815, 820, and 825. That is, cells that use not only the same frequency as the serving cell, but also different frequencies from the serving cell and neighbor the serving cell can be called neighbour cells.

The handover of UE from the serving cell to the intra-frequency neighbour cell 800 or 810 is called an intra-frequency handover. Meanwhile, the handover of UE from the serving cell to the inter-frequency neighbour cell 815, 820, or 825 is called an inter-frequency handover.

In order for packet data to be transmitted and received through a specific cell, UE first must complete the configuration of the specific cell or a CC. Here, the configuration means a state in which the reception of system information necessary for the transmission and reception of data for the corresponding cell or CC has been completed.

For example, the configuration can include a general process of receiving common physical layer parameters necessary for the transmission and reception of data, MAC layer parameters, or parameters necessary for a specific operation in the RRC layer. A configuration completion cell or CC is in a state in which packets can be instantly transmitted and received when only signaling information, indicating that the packet data can be transmitted, is received.

Meanwhile, a configuration completion cell can be present in an activation state or a deactivation state. The reason why the state of the configuration completion cell is divided into the activation state and the deactivation states is to allow UE to monitor or receive a control channel (PDCCH) and a data channel (PDSCH) only in the activation state so that the battery consumption of the UE is minimized.

Activation means that traffic data is being transmitted or received or is in the ready state. In order to check resources (they may be frequency and time resources) allocated to UE, the UE can monitor or receive the control channel (PDCCH) and data channel (PDSCH) of an activated cell.

Deactivation means that traffic data cannot be transmitted or received, but measurement or the transmission/reception of minimum information is possible. UE can receive System Information (SI) necessary to receive packets from a deactivated cell. In contrast, the UE does not monitor or receive the control channel (PDCCH) and data channel (PDSCH) of the deactivated cell in order to check resources (they may be frequency and time resources) allocated thereto.

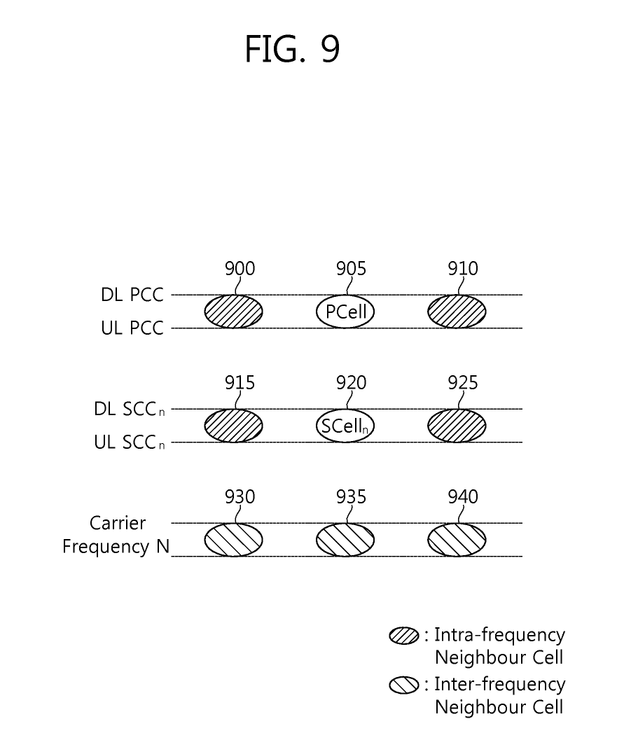

FIG. 9 is an explanatory diagram illustrating the concept of a primary serving cell and a secondary serving cell.

Referring to FIG. 9, a primary serving cell 905 refers to one serving cell which provides a security input and NAS mobility information in an RRC establishment or re-establishment state. At least one cell, together with the primary serving cell 905, can be configured to form a set of serving cells depending on UE capabilities. The at least one cell is called a secondary serving cell 920.

Accordingly, a set of the serving cells configured for one UE can include only one primary serving cell 905 or can include one primary serving cell 905 and at least one secondary serving cell 920.

The intra-frequency neighbour cells 900 and 910 of the primary serving cell 905 and/or the intra-frequency neighbour cells 915 and 925 of the secondary serving cell 920 belong to the same carrier frequency. Furthermore, the inter-frequency neighbour cells 930, 935, and 940 of the primary serving cell 905 and the secondary serving cell 920 belong to a different carrier frequency.

A DL CC corresponding to the primary serving cell 905 is called a downlink Primary Component Carrier (DL PCC), and an UL CC corresponding to the primary serving cell 905 is called an uplink Primary Component Carrier (UL PCC). Furthermore, in downlink, a CC corresponding to the secondary serving cell 920 is called a downlink Secondary Component Carrier (DL SCC). In uplink, a CC corresponding to the secondary serving cell 920 is called an uplink Secondary Component Carrier (UL SCC).

A PCC is a CC to which UE is connected or RRC-connected at the early stage, from among several CCs. A PCC is a special CC that is responsible for connection or RRC connection for signaling regarding a number of CCs and for the management of UE context information, that is, connection information related to the UE. Furthermore, a PCC is always in the activation state when the PCC is connected to UE and is in the RRC connected mode.

An SCC is a CC allocated to UE other than a PCC. An SCC is a carrier extended for the additional allocation of resources to UE other than a PCC and can be divided into an activation state and a deactivation state. The primary serving cell 905 and the secondary serving cell 920 have the following characteristics.

First, the primary serving cell 905 is used to transmit a PUCCH.

Second, the primary serving cell 905 is always activated, whereas the secondary serving cell 920 is a carrier activated or deactivated according to specific conditions.

Third, when the primary serving cell 905 experiences a Radio Link Failure (RLF), RRC re-establishment is triggered. However, when the secondary serving cell 920 experiences an RLF, RRC re-establishment is not triggered.

Fourth, the primary serving cell 905 can be changed by a change of a security key or a handover procedure accompanied by a Random Access CHannel (RACH) procedure. In the case of MSG4 contention resolution, only a PDCCH indicating MSG4 must be transmitted through the primary serving cell 905, and MSG4 information can be transmitted through the primary serving cell 905 or the secondary serving cell 920.

Fifth, NAS information is received through the primary serving cell 905.

Sixth, the primary serving cell 905 always includes a pair of a DL PCC and a UL PCC.

Seventh, a different CC can be configured as the primary serving cell 905 for every UE.

Eighth, procedures, such as the reconfiguration, addition, and removal of the secondary serving cell 920, can be performed by the RRC layer. In newly adding the secondary serving cell 920, RRC signaling can be used to transmit system information about a dedicated secondary serving cell.

The technical spirit of the present invention regarding the characteristics of the primary serving cell 905 and the secondary serving cell 920 is not necessarily limited to the above description, but can include more examples.

A DL CC can configure one serving cell, or a DL CC and a UL CC can be linked to each other, thus forming one serving cell. However, only one UL CC does not form a serving cell.

The activation/deactivation of a component carrier has the same concept as the activation/deactivation of a serving cell. For example, assuming that a serving cell is composed of a DL CC1, the activation of the serving cell means the activation of the DL CC1. Assuming that a DL CC2 and an UL CC2 are linked to each other in a serving cell2, the activation of the serving cell2 means the activation of the DL CC2 and the UL CC2. Furthermore, a primary serving cell corresponds to a PCC, and a secondary serving cell corresponds to an SCC.

UE can perform the following operations, such as those of Table 1, depending on whether the state of an UL CC is activation or deactivation.

TABLE 1

| STATE OF | | |
|---|---|---|
| UL CC | ACTIVATION | DEACTIVATION |
| OPERATION | If a periodic sounding | If a periodic sounding |
| OF UE | reference signal is configured, | reference signal is |
| | UE stops sending a | configured, UE restarts |
| | sounding reference signal. | sending a sounding |
| | | reference signal. |
| | UE disregards all uplink | UE receives an uplink |
| | grants for an UL CC. | grant for an UL CC. |
| | UE does not take a UE- | UE receives a PDCCH |
| | specific search space for an | for a UE-specific search |
| | UL CC into consideration | space for an UL CC. |

Linking between an UL CC and a DL CC related to activation/deactivation can be at least one of System Information Block2 (SIB2) linking, scheduling linking, and pathloss reference linking.

In SIB2 linking, an SIB2 is information that is broadcasted to all cells. The SIB2 includes the location of a center frequency for an UL CC, bandwidth information, etc. In a primary serving cell, UE receives information broadcasted by a cell, and thus all pieces of UE which have configured the cell as a primary serving cell can configure the same DL CC and UL CC as a primary serving cell by linking the DL CC and UL CC. In a secondary serving cell, a BS dedicatedly transmits SIB2 information through a primary serving cell. Thus, each UE which has configured a corresponding cell as a secondary serving cell can configure a secondary serving cell by linking different DL CC and UL CC.

In scheduling linking, when there is a DL CC on which a PDCCH for an UL CC is transmitted, the UL CC and the DL CC are considered to be linked.

In pathloss reference linking, when there is a DL CC referred for pathloss estimation for an UL CC, the UL CC and the DL CC are considered to be linked.

In addition, linking between an UL CC and a DL CC related to activation/deactivation can be defined from various aspects, and the technical spirit of the present invention is not limited to the above description.

It is preferred that a DL PCC and an UL PCC corresponding to a primary serving cell be always activated from a viewpoint of compatibility with the existing system (e.g., LTE) and the transmission of system information. However, a DL SCC and an UL SCC corresponding to a secondary serving cell does not need to be always activated and can be adaptively activated or deactivated depending on the efficient distribution of a spectrum and scheduling condition.

When an UL CC linked to a DL CC is additionally configured after the DL CC is configured, there are ambiguities regarding that the initial state of the UL CC will be reset to any one of the activation state and the deactivation state. For example, it is assumed that a BS transmits an uplink grant regarding an UL CC right after the UL CC has been configured. If the UL CC is reset to activation, the BS can download the uplink grant regarding the UL CC to UE without performing additional signaling. In contrast, if the UL CC is reset to deactivation, the BS has to first activate the UL CC through additional signaling and then download the uplink grant regarding the UL CC to the UE. That is, the ambiguities of an UL CC regarding activation/deactivation must be solved in advance because whether a BS has to perform additional signaling for the activation/deactivation of the UL CC or not is determined in each situation.

In order to solve the ambiguities, when an UL CC is configured additionally in a multiple component carrier system, it is necessary to clearly define how the initial state of the UL CC will be configured. In this case, it is a precondition that a DL CC linked to the UL CC has already been configured and the activation/deactivation of the DL CC is disregarded. Meanwhile, only a case where an UL CC is configured additionally is described as a target, but this can be likewise applied to a case where a DL CC is configured additionally.

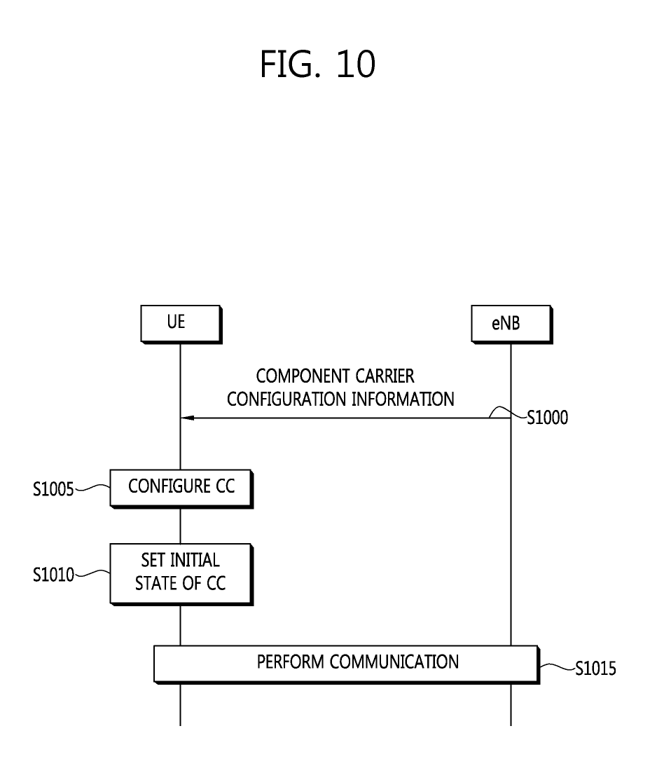

FIG. 10 is a flowchart illustrating a method of initializing a CC in a multiple component carrier system in accordance with an example of the present invention.

Referring to FIG. 10, a BS transmits component carrier configuration information to UE (S1000). The component carrier configuration information is information indicating that a DL CC and/or an UL CC should be configured in the UE. The component carrier configuration information may also be called CC-additional information. The component carrier configuration information can be included in a Radio Resource Control (RRC) message.

The RRC message can be any one of an RRC connection establishment-related message that induces initial RRC establishment, an RRC connection re-establishment-related message that induces RRC connection re-establishment in a situation, such as a radio link failure, and an RRC connection reconfiguration-related message that induces the reconfiguration of RRC establishment. Or, the component carrier configuration information can be any one of a Medium Access Control (MAC) message or the message of a physical layer.

The UE configures a CC that is indicated by the component carrier configuration information (S1005). The CC may be only a DL CC, may be only an UL CC linked to an already configured DL CC, or may be both a DL CC and an UL CC.

The UE configures the initial state of the configured CC (S1010). The initial state of the configured CC means a state in which the configured CC is first taken in activation or deactivation. The initial state may be taken simultaneously when the CC is configured or may be taken after the CC is configured. The initial state may also be called a default state. The configuration of the initial state of the configured CC includes the meaning that the configured CC is initialized. The initial state of the configured CC can be any one of activation and deactivation. If the initial state of the configured CC is basically deactivation, the BS must transmit additional activation-related signaling to the UE in order to activate the configured CC.

The UE and the BS perform communication, such as the transmission and reception of control information and data, using the configured CC (S1015).

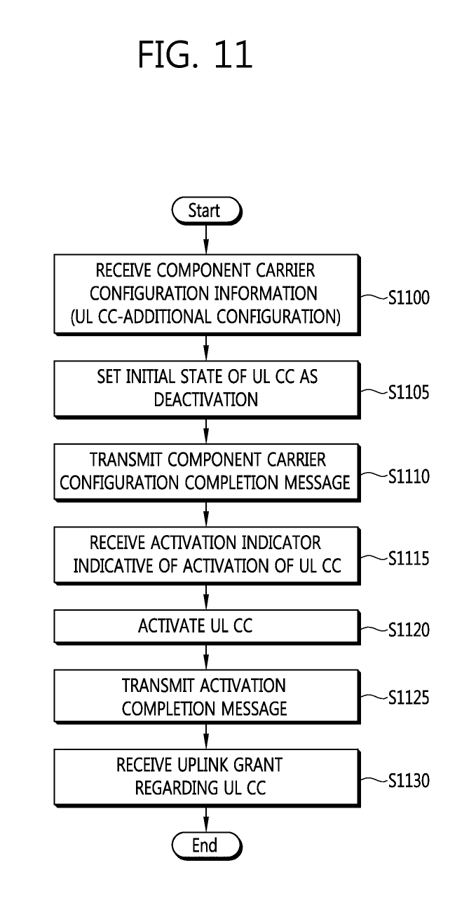

FIG. 11 is a flowchart illustrating a method of UE initializing a CC in a multiple component carrier system in accordance with an example of the present invention. Here, it is a precondition that the initialized CC is an UL CC and a DL CC linked to the UL CC has already been configured and activated. The UL CC may be an UL PCC or an UL SCC. Furthermore, the UL CC corresponds to one serving cell. Accordingly, the initial state of the UL CC can be used as the same concept as the initial state of the one serving cell.

Referring to FIG. 11, the UE receives component carrier configuration information, indicating that an UL CC should be configured, from a BS (S1100). The format of the component carrier configuration information has been described with reference to FIG. 10. The component carrier configuration information may also be called CC-additional configuration information because the UL CC is additionally configured in the state in which a DL CC linked to the UL CC has already been configured.

The UE configures the UL CC, but deactivates the initial state of the UL CC (S1105). In this case, the DL CC linked to the UL CC forms one serving cell along with the UL CC. Since the UL CC has been deactivated, the UE does not transmit a sounding reference signal although sounding reference signal setup information on the UL CC is included in the component carrier configuration information. Furthermore, the UE does not receive a UE-specific uplink grant for the UL CC. That is, the UE does not perform blind decoding related to a UE-specific PDCCH which includes an uplink grant. Here, blind decoding is a decoding method of defining a specific decoding start point in the region of a predetermined PDCCH, performing decoding on all Downlink Control Information (DCI) formats available in given transmission mode, and distinguishing users from each other based on C-RNTI information masked to CRC.

After the configuration of the UL CC and the configuration of the initial state are completed (i.e., after the additional configuration of the UL CC is completed), the UE transmits a component carrier configuration completion message to the BS (S1110). For example, if the component carrier configuration information is an RRC connection reconfiguration message, the component carrier configuration completion message is an RRC connection reconfiguration completion message. For another example, if the component carrier configuration information is an RRC connection re-establishment message, the component carrier configuration completion message is an RRC connection re-establishment completion message. For yet another example, if the component carrier configuration information is an RRC connection establishment message, the component carrier configuration completion message is an RRC connection establishment completion message.

The UE receives an activation indicator indicative of activation for the configured UL CC from the BS (S1115). The activation indicator is a control message that is generated in a physical layer, a MAC layer, or an RRC layer.

The UE activates the configured UL CC (S1120). The concept of the activation of a CC has been described with reference to FIGS. 8 and 9. The UE transmits an activation indicator reception completion message, indicating that the activation indicator has been successfully received, to the BS (S1125). Next, the UE receives an uplink grant regarding the UL CC (S1130).

The uplink grant is Downlink Control Information (DCI) of a format for uplink resource allocation to the UE and is transmitted on a PDCCH. The uplink grant is configured as in Table 2.

```
TABLE 2
  Flag for distinguishing Format 0 or Format 1A - 1 bit, when the flag is 0,
it indicates Format 0, and when the flag is 1, it indicates Format 1A.
  Frequency hopping flag - 1 bit
  Resource block allocation and hopping resource allocation -
  |log₂(N_{RB}^{UL}(N_{RB}^{UL} + 1)/2)|bit
  In the case of PUSCH hopping:
    N_{UL}_{_{—}}ₕₒₚ MSB bits are used to obtain a value of ñ_{PRB} (i)
    (|log₂(N_{RB}^{UL}(N_{RB}^{UL} + 1)/2)| − N_{UL}_{_{—}}ₕₒₚ)bits provide the
resource allocation of No. 1 slot of an uplink subframe
    In the case where PUSCH hopping is not:
      (|log₂(N_{RB}^{UL}(N_{RB}^{UL} + 1)/2)|) bits provide resource allocation within
an uplink subframe
  Modulation and coding scheme/redundancy version - 5 bits
  New data indicator - 1 bit
  TPC command for scheduled PUSCH - 3 bits
  Cyclic shift for DMRS - 3 bits
  UL index - 2 bits (this field is present only in a TDD operation according
to an uplink-downlink configuration 0
  Downlink Assignment Index (DAI) - 2 bits (this field is present for all
downlink-uplink configurations in TDD
  CQI request - 1 bit
  Carrier Index Field (CIF) - 3 bits (this field is present for only CA.
```

Referring to Table 2, the uplink grant includes pieces of information, such as an RB, a Modulation and Coding Scheme (MCS), and a TPC.

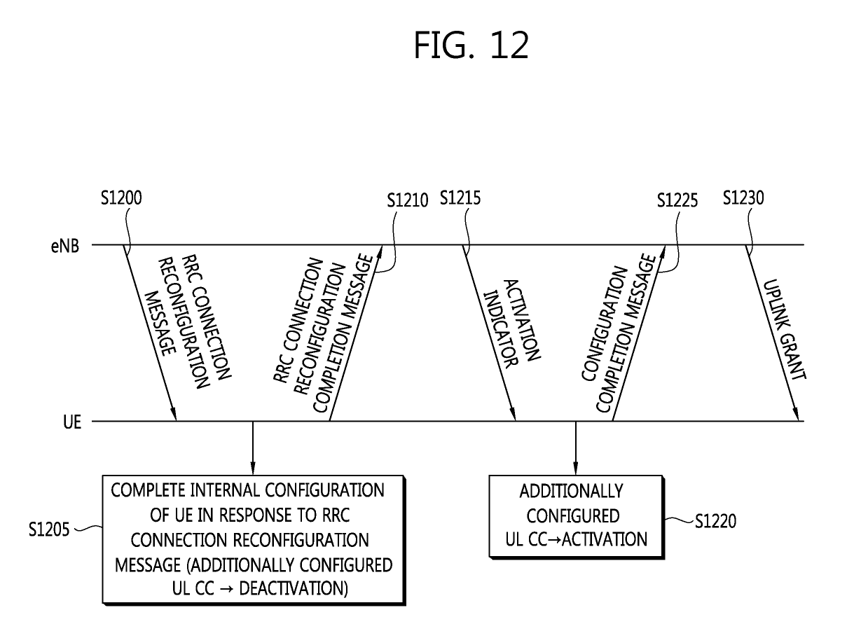

FIG. 12 is a signal flow between UE and an eNB according to the initializing method of FIG. 11. It is here assumed that component carrier configuration information is included in an RRC connection reconfiguration message.

Referring to FIG. 12, when the UE receives an RRC connection reconfiguration message for the configuration of an UL CC from the eNB (S1200), the UE completes the internal reconfiguration of the UE in response to the RRC connection reconfiguration message after a lapse of some time (S1205).

Next, there can be a time lag until the UE transmits an RRC connection reconfiguration completion message to the eNB (S1210). Accordingly, the configuration of the UL CC is completed at a timing when the UE completes its internal reconfiguration in response to the RRC connection reconfiguration message. Furthermore, a configuration for deactivating the initial state of the UL CC is also completed.

The eNB may want uplink reception from the UE through the UL CC or the UE may want uplink transmission to the eNB through the UL CC. For the purpose of uplink transmission, first, the UE has to obtain an uplink grant and the UL CC has to be activated. However, since the UL CC is now deactivated, the eNB transmits an activation indicator indicative of the activation of the UL CC to the UE (S1215). The activation indicator can be the message of a physical layer, a MAC layer, or an RRC layer.

The UE that has received the activation indicator activates the UL CC (S1220). After the configuration of activation/deactivation for a serving cell is completed, the UE transmits an activation completion message to the eNB (S1225). The eNB can transmit an uplink grant for the UL CC to the UE after checking the activation completion message (S1230).

As described above, in accordance with the method in which the initial state of an additionally configured UL CC is basically deactivated and the UL CC is activated when an eNB transmits an additional activation indicator to UE, if necessary, the ambiguities of the initial state of the UL CC additionally configured between the UE and the eNB can be eliminated.

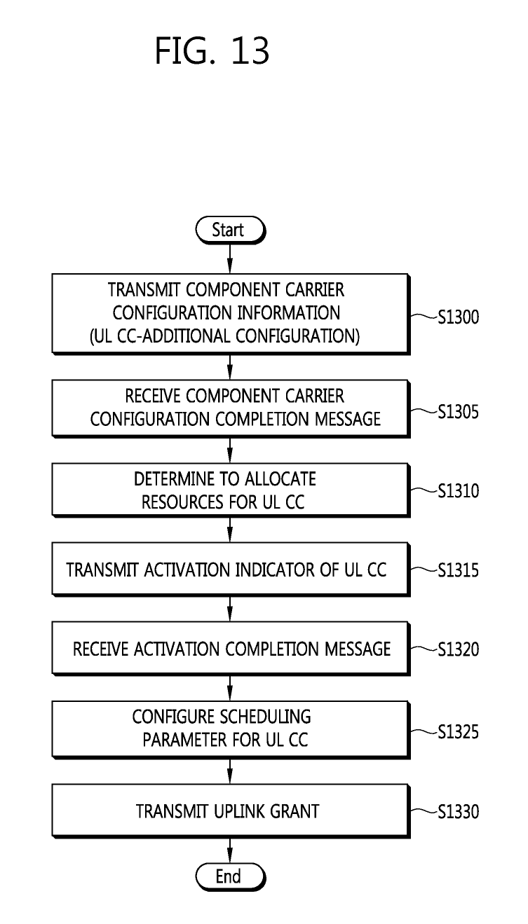

FIG. 13 is a flowchart illustrating a method of an eNB initializing a CC in a multiple component carrier system in accordance with an example of the present invention. It is here a precondition that an initialized CC is an UL CC and a DL CC linked to the UL CC has already been configured and activated. The UL CC may be an UL PCC and may be an UL SCC. Furthermore, the UL CC corresponds to one serving cell. Accordingly, the initial state of the UL CC can be used as the same concept as the initial state of the one serving cell.

Referring to FIG. 13, the eNB transmits component carrier configuration information indicative of the configuration of an UL CC to UE (S1300). The format of the component carrier configuration information has been described with reference to FIG. 10. The component carrier configuration information may also be called CC-additional configuration information because the UL CC is additionally configured in the state in which a DL CC linked to the UL CC has been configured in advance.

The eNB receives a component carrier configuration completion message, indicating that the configuration of the UL CC has been completed, from the UE (S1305). The eNB determines the allocation of resources (i.e., uplink scheduling) to the UL CC (S1310) and transmits an activation indicator indicative of the activation of the UL CC (or the activation of a serving cell corresponding to the UL CC) to the UE (S1315). The activation indicator can be the message of a physical layer, a MAC layer, or an RRC layer.

The eNB receives an activation completion message, indicating that the activation of the UL CC has been completed, from the UE (S1320).

The eNB configures a scheduling parameter for the UL CC (S1325) and transmits an uplink grant according to the configured scheduling parameter to the UE (S1330).

A method of deactivating the initial state of a DL CC right after an UL CC is configured irrespective of the state of the DL CC has been described so far. Methods of determining the initial state of an UL CC depending on the state of a DL CC are hereinafter described. First, a case where the initial state of an additionally configured UL CC is activated because a DL CC is deactivated is described.

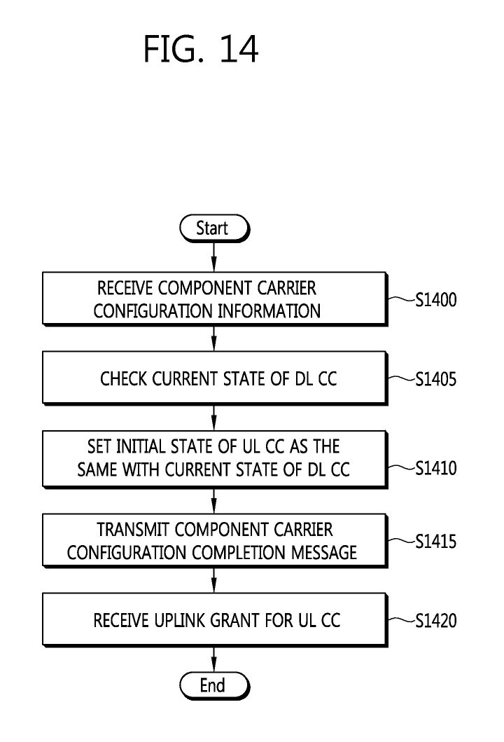

FIG. 14 is a flowchart illustrating a method of UE initializing a CC in a multiple component carrier system in accordance with another example of the present invention. It is a precondition that a DL CC linked to an UL CC to be additionally configured has already been activated. The UL CC may be an UL PCC and may be an UL SCC. Furthermore, the UL CC corresponds to one serving cell. Accordingly, the initial state of the UL CC can be used as the same concept as the initial state of the one serving cell.

Referring to FIG. 14, the UE receives component carrier configuration information, indicating that an UL CC should be configured, from an eNB (S1400). The format of the component carrier configuration information has been described with reference to FIG. 10. The component carrier configuration information may also be called CC-additional configuration information because the UL CC is additionally configured in the state in which a DL CC linked to the UL CC has been configured in advance. The UL CC and the DL CC correspond to one serving cell.

The UE checks the current state of the DL CC linked to the UL CC (S1405). The current state of the DL CC is a state indicating whether the DL CC has been activated or has been deactivated when the current state is checked.

The UE configures the initial state of the UL CC so that the initial state of the UL CC becomes identical with the current state of the DL CC (S1410). Since the current state of the DL CC is activation, the UE activates the initial state of the UL CC. Of course, if the current state of the DL CC is deactivation, the UE will deactivate the initial state of the UL CC. That is, the initial state of the UL CC basically depends on the current state of the DL CC linked to the UL CC. Thus, the ambiguities of the initial state of the UL CC right after the UL CC is configured can be eliminated.

The UE transmits a component carrier configuration completion message, indicating that the configuration of the UL CC has been completed, to the eNB (S1415). For example, if the component carrier configuration information is an RRC connection reconfiguration message, the component carrier configuration completion message is an RRC connection reconfiguration completion message. For another example, if the component carrier configuration information is an RRC connection re-establishment message, the component carrier configuration completion message is an RRC connection re-establishment completion message. For yet another example, if the component carrier configuration information is an RRC connection establishment message, the component carrier configuration completion message is an RRC connection establishment completion message.

Since the UL CC has bee configured and immediately activated without additional signaling, the UE can receive an uplink grant from the eNB (S1420).

The concept of the activation of a serving cell is based on the descriptions of FIGS. 8 and 9. When the initial state of a serving cell is activation, if information on the configuration of a sounding reference signal for an UL CC is included in the component carrier configuration information, UE transmits the sounding reference signal based on the information on the configuration of the sounding reference signal. Furthermore, the UE receives a UE-specific uplink grant for the UL CC. That is, the UE performs a blind decoding procedure that is related to a UE-specific PDCCH including an uplink grant.

The operation of an eNB is described below in a method in which the initial state of an additionally configured UL CC depends on the current state of a DL CC linked to the UL CC.

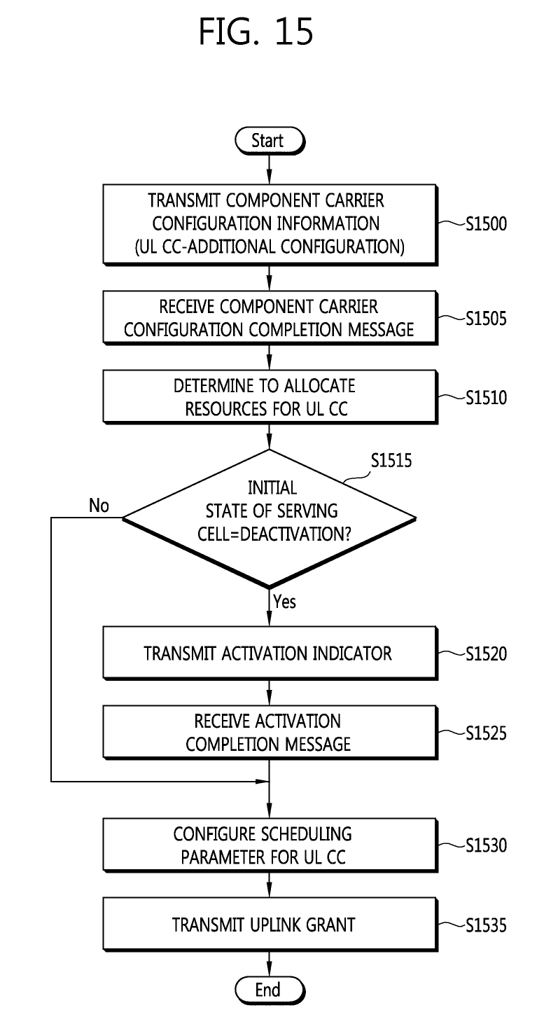

FIG. 15 is a flowchart illustrating a method of an eNB initializing a CC in a multiple component carrier system in accordance with another example of the present invention. It is here a precondition that the initialized CC is an UL CC and a DL CC linked to the UL CC has already been configured. The UL CC may be an UL PCC and may be an UL SCC. Furthermore, the UL CC corresponds to one serving cell. Accordingly, the initial state of the UL CC can be used as the same concept as the initial state of the one serving cell.

Referring to FIG. 15, the eNB transmits component carrier configuration information indicative of the configuration of an UL CC to UE (S1500). The format of the component carrier configuration information has been described with reference to FIG. 10. The component carrier configuration information may also be called CC-additional configuration information because the UL CC is additionally configured in the state in which a DL CC linked to the UL CC has been configured in advance.

The UL CC and the DL CC correspond to a serving cell. Accordingly, the activation of the UL CC and the DL CC means the activation of the serving cell, and the deactivation of the UL CC and the DL CC means the deactivation of the serving cell. Since the initial state of the UL CC has been set to be identical with the current state of the DL CC, activation/deactivation are described from a viewpoint of a serving cell including both the UL CC and the DL CC.

The eNB receives a component carrier configuration completion message, indicating that the configuration of the UL CC has been completed, from the UE (S1505). The eNB determines the allocation of resources (i.e., uplink scheduling) to the UL CC (S1510) and determines whether the initial state of the serving cell is deactivation or activation (S1515). If the initial state of the serving cell is deactivation, the eNB transmits an activation indicator indicative of the activation of the serving cell to the UE (S1520). The activation indicator can be the message of a physical layer, a MAC layer, or an RRC layer. The eNB receives an activation completion message, indicating that the activation of the serving cell has been completed, from the UE (S1525). Here, the activation of the serving cell can mean that both the UL CC and a DL CC correspond to the serving cell are activated.

The eNB configures a scheduling parameter for the UL CC (S1530) and transmits an uplink grant according to the configured scheduling parameter to the UE (S1535). The eNB can transmit the uplink grant including Aperiodic Sounding Reference Signal (A-SRS)-related information (e.g., triggering information or A-SRS configuration information), if necessary.

If the initial state of the serving cell is activation at step S1515, the eNB configures a scheduling parameter for the UL CC (S1530) and transmits an uplink grant according to the configured scheduling parameter to the UE (S1535), without transmitting an activation indicator.

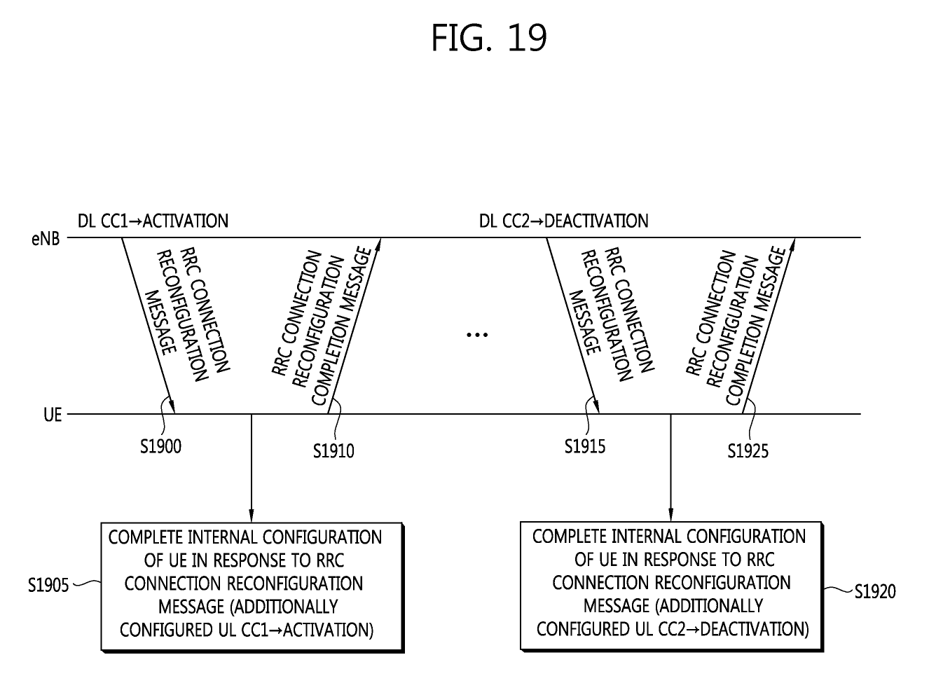

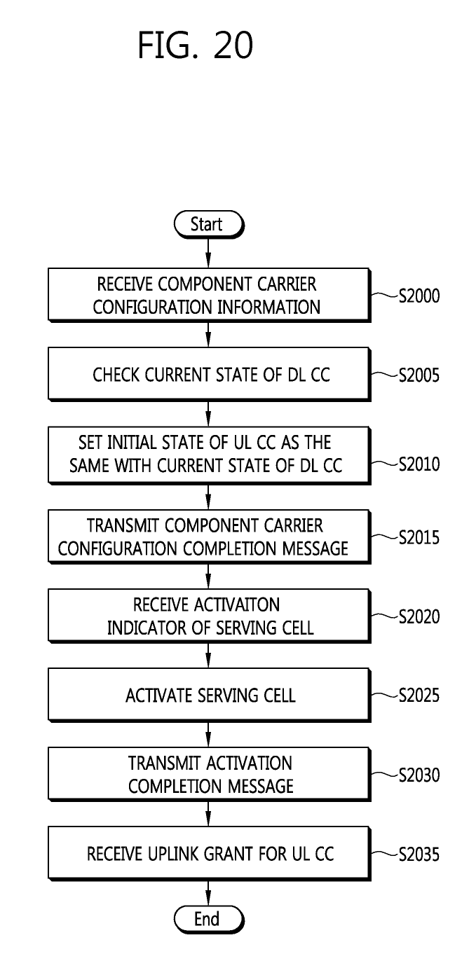

A method of an eNB selecting an UL CC to be additionally configured is described below. The method of selecting an UL CC to be additionally configured can be combined with the method of setting the initial state of an UL CC and can be included at a specific position in order of FIGS. 10 to 15. In particular, after selecting an UL CC to be additionally configured, an eNB can transmit component carrier configuration information indicative of the configuration of the UL CC to UE. For example, the method of selecting an UL CC to be additionally configured can be performed by an eNB prior to the step S1000 of FIG. 10, prior to the step S1200 of FIG. 12, prior to the step S1300 of FIG. 13, prior to the step S1500 of FIG. 15, prior to a step S1900 of FIG. 19, and prior to a step S2000 of FIG. 20. Of course, the step of selecting an UL CC to be additionally configured does not need to be necessarily performed prior to the transmission of component carrier configuration information.

A case where the additional configuration of an UL CC is necessary for UE is as follows: i) a case where additional uplink resources are necessary because an uplink transfer rate required by UE is increased and ii) a case where the resource allocation of UL CCs already allocated to UE is not easy. The case ii) includes, for example, a case where if the amount of resources required by UE has increased, but uplink resources necessary for UE cannot be allocated to the UE through UL CCs because the total use rate of the UL CCs is high, there is no change in the amount of resources required by the UE, but the amount of resource allocation for the UL CCs must be reduced in order to adjust a balance between the UL CCs of a load.

An eNB can select an UL CC to be additionally configured on the basis of the current state of a DL CC. The UL CC to be additionally configured is selected dependently on the order of priority of the DL CC.

For example, an eNB can select an UL CC to be additionally configured on the basis of the activation state of a DL CC. In this case, the initial state of the UL CC is set to be identical with the current state of the DL CC, wherein the additionally configured UL CC is linked to the DL CC that has already been activated. Thus, an eNB can transmit an uplink grant even without an additional activation indicator.

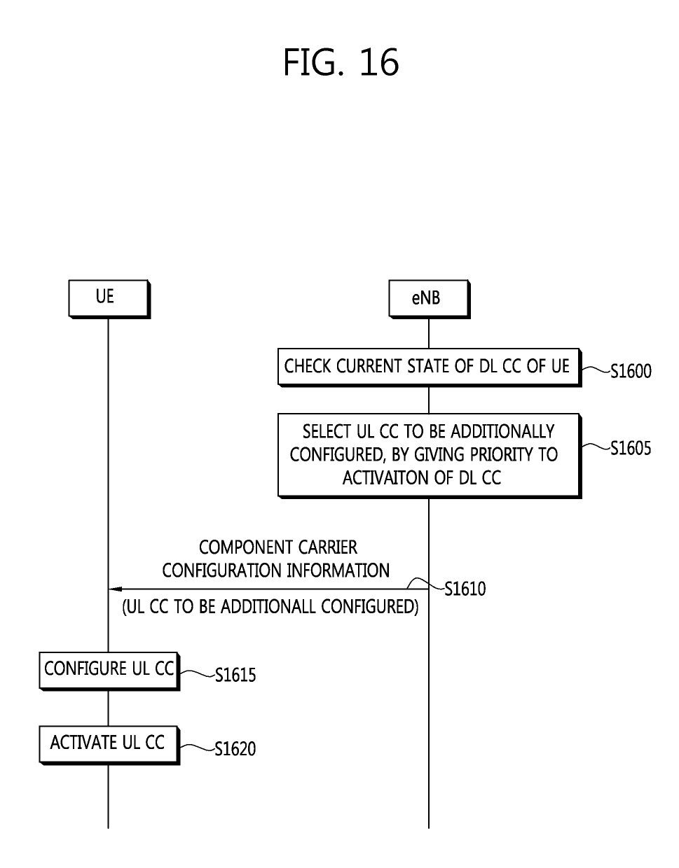

FIG. 16 is a flowchart illustrating a method of selecting an UL CC to be additionally configured in accordance with an example of the present invention.

Referring to FIG. 16, an eNB checks whether the current state of a DL CC, from among serving cells including only DL CCs, is activation or deactivation (S1600). The eNB preferentially selects an UL CC, linked to an activated DL CC, as an UL CC to be additionally configured (S1605). That is, the UL CC to be additionally configured is selected by placing priority to the activation of a DL CC.

The eNB transmits component carrier configuration information, indicating that the selected UL CC should be configured, to UE (S1610). Next, the UE configures the selected UL CC (S1615) and sets the initial state of the selected UL CC as activation that is identical with the current state of the DL CC (S1620).

In this case, unlike a serving cell whose DL CC has been deactivated, an activation indicator does not need to be additionally transmitted in order to send an uplink grant for an additionally configured UL CC. Accordingly, a procedure for using an UL CC to be additionally configured can be reduced to the highest degree.

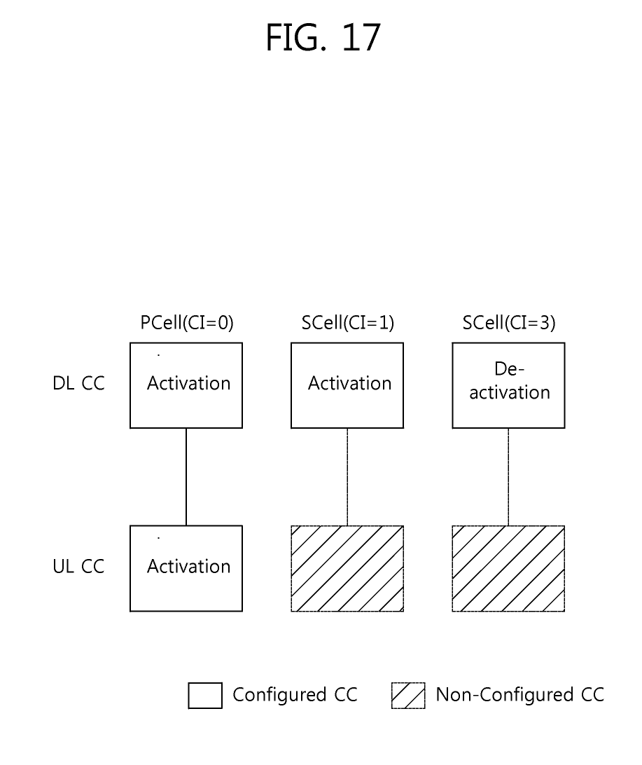

FIG. 17 is a conceptual diagram illustrating the method of selecting an UL CC according to FIG. 16.

Referring to FIG. 17, three DL CCs having respective Carrier Indices (CI) 0, 1, and 2 are now configured in UE, and one UL CC having a CI 0 is configured. From among them, both the DL CC and the UL CC corresponding to a primary serving cell (CI=0) are in an activated state, the DL CC corresponding to a first secondary serving cell (CI=1) is in an activated state, and the DL CC corresponding to a second secondary serving cell (CI=2) is in a deactivated state.

Here, candidates for UL CCs to be additionally configured in the UE by an eNB area the first secondary serving cell (CI=1) and the second secondary serving cell (CI=2). The DL CC of the first secondary serving cell (CI=1) has already been activated, but the DL CC of the second secondary serving cell (CI=2) has been deactivated. If priority is given to the activation of a DL CC linked to an UL CC in selecting UL CCs, the UL CC belonging to the first secondary serving cell (CI=1) is selected as an UL CC to be additionally configured. Accordingly, the eNB can transmit component carrier configuration information, requesting the configuration of the UL CC belonging to the first secondary serving cell (CI=1), to UE.

The above example is only illustrative, priority does not need to be necessarily given to an activated DL CC, and an UL CC to be additionally configured may be selected by giving priority to a deactivated DL CC or may be selected randomly irrespective of a DL CC.

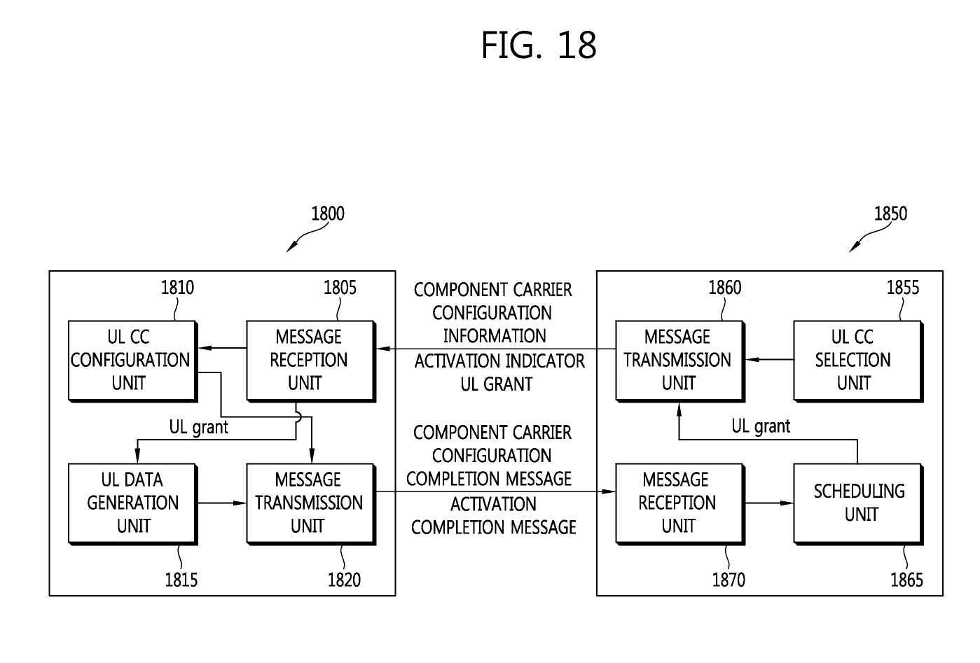

FIG. 18 is a block diagram showing UE and an eNB in accordance with an example of the present invention.

Referring to FIG. 18, the UE 1800 includes a message reception unit 1805, an uplink component carrier (UL CC) configuration unit 1810, an UL data generation unit 1815, and a message transmission unit 1820.

The message reception unit 1805 receives messages, such as component carrier configuration information, an activation indicator, and an uplink grant, from the eNB 1850.

The UL CC configuration unit 1810 configures an UL CC indicated by the component carrier configuration information. Here, the UL CC configuration unit 1810 basically deactivates the initial state of the UL CC. Furthermore, the current state of a DL CC linked to the UL CC is ignored. Or, the UL CC configuration unit 1810 activates or deactivates the initial state of the UL CC so that the initial state of the UL CC is identical with the current state of the DL CC. In addition, the operation of the UL CC configuration unit 1810 includes all the methods of setting the initial state of an UL CC proposed in FIGS. 10 to 15.

Furthermore, the UL CC configuration unit 1810 activates the UL CC whose initial state is deactivation based on the activation indicator received from the eNB 1850.

The UL data generation unit 1815 generates uplink data based on information on resource allocation according to the uplink grant, an MCS, etc. and transmits the uplink data to the message transmission unit 1820.

When the configuration of a CC is completed by the UL CC configuration unit 1810, the message transmission unit 1820 transmits a component carrier configuration completion message to the eNB 1850. Furthermore, when an UL CC whose initial state is deactivation is activated by the UL CC configuration unit 1810, the message transmission unit 1820 transmits an activation completion message to the eNB 1850.

The eNB 1850 includes an UL CC selection unit 1855, a message transmission unit 1860, a scheduling unit 1865, and a message reception unit 1870.

The UL CC selection unit 1855 selects an UL CC that will be additionally configured in the UE 1800 by the eNB 1850. Here, a method in which the UL CC selection unit 1855 selects the UL CC to be additionally configured includes the processes in FIGS. 16 and 17.

The message transmission unit 1860 transmits component carrier configuration information to the UE 1800 so that the UL CC selected by the UL CC selection unit 1855 is configured in the UE 1800. Furthermore, the message transmission unit 1860 transmits an uplink grant necessary for the uplink transmission of the UE 1800 and an activation indicator indicative of the activation of a deactivated UL CC to the UE 1800.

The scheduling unit 1865 configures a scheduling parameter for the UL CC, generates an uplink grant according to the configured scheduling parameter, and sends the uplink grant to the message transmission unit 1860.

The message reception unit 1870 receives a component carrier configuration completion message, an activation completion indicator, or uplink data from the UE 1800.

FIG. 19 is a signal flow between UE and an eNB according to the methods of initializing an UL CC in FIGS. 14 and 20. A description is given assuming that component carrier configuration information is included in an RRC connection reconfiguration message.

Referring to FIG. 19, an eNB transmits an RRC connection reconfiguration message to UE (S1900). The RRC connection reconfiguration message includes component carrier configuration information. Here, the current state of a DL CC 1 is activation.

The UE completes its internal configuration in response to the RRC connection reconfiguration message (S1905). Here, an UL CC1 linked to the DL CC1 is additionally configured. However, the initial state of the UL CC 1 is activated because the current state of the DL CC1 is activation.

The UE transmits an RRC connection reconfiguration completion message to the eNB (S1910).

Next, it is assumed that the current state of a DL CC2 is deactivation. The eNB transmits an RRC connection reconfiguration message for additionally configuring the UL CC2 to the UE (S1915). The UE completes its internal configuration in response to the RRC connection reconfiguration message (S1920). Here, an UL CC2 linked to the DL CC2 is additionally configured. Since the current state of the DL CC2 is deactivation, the initial state of the UL CC2 is deactivated. Here, the UE receives an activation indicator message from the eNB and activates the serving cell of the UL CC2 based on the activation indicator message. In this case, the UE may transmit an activation completion message.

Or, the eNB may transmit an RRC connection reconfiguration message for adding and activating the UL CC2 to the UE. In this case, the UE can inform the eNB of the addition and activation configuration of the UL CC2 through an RRC connection reconfiguration completion message. Next, the UE transmits an RRC connection reconfiguration completion message to the eNB (S1925).

FIG. 20 is a flowchart illustrating a method of UE initializing a CC in a multiple component carrier system in accordance with another example of the present invention. FIG. 20 is contrasted with FIG. 14, and it is a precondition that a DL CC linked to an UL CC has been deactivated. The UL CC may be an UL PCC and may be an UL SCC. Furthermore, the UL CC corresponds to one serving cell. Accordingly, the initial state of the UL CC can be used as the same concept as the initial state of the one serving cell.

Referring to FIG. 20, the UE receives component carrier configuration information, instructing that an UL CC should be configured, from an eNB (S2000). The format of the component carrier configuration information has been described with reference to FIG. 10. The component carrier configuration information may also be called CC-additional configuration information because the UL CC is additionally configured in the state I which a DL CC linked to the UL CC has been configured in advance. The UL CC and the DL CC correspond to one serving cell.

The UE checks the current state of the DL CC linked to the UL CC (S2005). The current state of the DL CC is a state indicating whether the DL CC has been activated or has been deactivated when the current state of the DL CC linked to the UL CC is checked.

The UE sets the initial state of the UL CC so that the initial state of the UL CC is identical with the current state of the DL CC (S2010). Since the current state of the DL CC is deactivation, the UE deactivates the initial state of the UL CC.

The UE transmits a component carrier configuration completion message, indicating that the configuration of the UL CC has been completed, to the eNB (S2015).

When the initial state of the UL CC is deactivation, it also indicates that the DL CC has also been deactivated. Accordingly, in order to receive an uplink grant, the UE has to first activate a serving cell corresponding to the UL CC and the DL CC. To this end, the UE receives an activation indicator (i.e., a message that activates both the UL CC and the DL CC) for the serving cell from the eNB (S2020).

The UE activates the serving cell based on the activation indicator (S2025). Accordingly, both the UL CC and the DL CC are activated. The UE transmits an activation completion message, indicating that the activation of the serving cell has been completed, to the eNB (S2030). The UE receives an uplink grant regarding the UL CC, corresponding to the activated serving cell, from the eNB (S2035).

When the initial state of the serving cell is deactivation, the UE does not transmit a sounding reference signal although information on the configuration of the sounding reference signal for the UL CC is included in the component carrier configuration information. Furthermore, a UE-specific uplink grant for the UL CC is ignored. That is, the UE does not perform a blind decoding procedure related to a UE-specific PDCCH including the uplink grant. Next, when an activation indicator for the serving cell is received, the UE activates the UL CC.

All the aforementioned functions can be executed by a processor, such as a microprocessor, a controller, a microcontroller, or Application Specific Integrated Circuits (ASICs) according to software or a program code coded to perform the functions. The design, development, and implementation of the code will be evident to a person having ordinary skill in the art on the basis of the description of the present invention.

Although the embodiments of the present invention have been described above, a person having ordinary skill in the art will appreciate that the present invention may be modified and changed in various ways without departing from the technical spirit and scope of the present invention. Accordingly, the present invention is not limited to the embodiments and it may be said that the present invention includes all embodiments within the scope of the claims below.

1. A method of a user equipment (UE) configuring a component carrier in a multiple component carrier system, the method comprising the steps of:
receiving component carrier configuration information for configuring a secondary component carrier from a base station;
configuring a secondary component carrier, indicated by the component carrier configuration information, in the UE; and
setting an initial state of the secondary component carrier as activation or deactivation.

2. The method of claim 1, wherein:
the secondary component carrier is an uplink secondary component carrier, and
the uplink secondary component carrier is linked to a downlink secondary component carrier configured in the UE.

3. The method of claim 2, wherein:
if the downlink component carrier is in activation, an initial state of the uplink component carrier is set as activation, and
if the downlink component carrier is in deactivation, the initial state of the uplink component carrier is set as deactivation.

4. The method of claim 1, further comprising the step of:
transmitting an activation completion message, indicating that the initial state of the secondary component carrier is set as activation or deactivation, to the base station.

5. A UE for configuring a component carrier in a multiple component carrier system, comprising:
a message reception unit for receiving component carrier configuration information for configuring a secondary component carrier from a base station; and
an uplink component carrier configuration unit for configuring a secondary component carrier, indicated by the component carrier configuration information, in the UE and setting an initial state of the secondary component carrier as activation or deactivation.

6. The UE of claim 5, wherein:
the secondary component carrier is an uplink secondary component carrier, and
the uplink secondary component carrier is linked to a downlink secondary component carrier configured in the UE.

7. The UE of claim 6, wherein the uplink component carrier configuration unit sets an initial state of the uplink component carrier as activation if the downlink component carrier is in activation, or
the uplink component carrier configuration unit sets the initial state of the uplink component carrier as deactivation if the downlink component carrier is in deactivation.

8. The UE of claim 5, further comprising:
a message transmission unit for transmitting an activation completion message, indicating that the initial state of the secondary component carrier is set as activation or deactivation, to the base station.

9. A method of a base station configuring a component carrier in a multiple component carrier system, the method comprising the steps of:
transmitting, to the UE, component carrier configuration information for configuring a secondary component carrier in a UE;
receiving a component carrier configuration completion message, indicating that the configuration of the secondary component carrier is completed based on the component carrier configuration information, from the UE;
transmitting, to the UE, an activation indicator indicative of an activation of the secondary component carrier if an initial state of the secondary component carrier is set as deactivation; and
receiving an activation completion message, indicating that the activation of the secondary component carrier is completed, from the UE.

10. The method of claim 9, wherein:
the secondary component carrier is an uplink secondary component carrier, and
the uplink secondary component carrier is linked to a downlink secondary component carrier configured in the UE.

11. The method of claim 10, wherein:
the downlink component carrier is in a deactivation state, and
an initial state of the uplink component carrier is set as deactivation which is the same in the downlink component carrier.

12. A base station for configuring a component carrier in a multiple component carrier system, comprising:
a message transmission unit for transmitting component carrier configuration information for configuring a secondary component carrier in a UE to the UE and transmitting an activation indicator indicative of an activation of the secondary component carrier to the UE if an initial state of the secondary component carrier is set as deactivation; and
a message reception unit for receiving a component carrier configuration completion message, indicating that the configuration of the secondary component carrier is completed based on the component carrier configuration information, from the UE and receiving an activation completion message, indicating that the activation of the secondary component carrier is completed, from the UE.

13. The base station of claim 12, wherein:
the secondary component carrier is an uplink secondary component carrier, and
the uplink secondary component carrier is linked to a downlink secondary component carrier configured in the UE.

14. The base station of claim 13, wherein:
the downlink component carrier is in a deactivation state, and
an initial state of the uplink component carrier is set as deactivation which is the same in the downlink component carrier.
